(19) United States
(12) Patent Application Publication
(10) Pub. No.: US 2008/0123347 A1
(43) Pub. Date: May 29, 2008

(54) METHOD FOR MOLDING DIFFUSION BOARD OF DIRECT TYPE BACKLIGHT MODULE AND APPLICATION THEREOF

(76) Inventor: Chien-Chin Mai, Reawn Shiang (TW)

Correspondence Address: LEONG C LEI, PMB # 1008, 1867 YGNACIO VALLEY ROAD, WALNUT CREEK, CA, 94598, US

(21) Appl. No.: 11/557,505

(22) Filed: Nov. 8, 2006

(51) Int. Cl. F21V 3/00; B29D 11/00

(52) U.S. Cl. 362/311; 264/2.7

(57) ABSTRACT

Disclosed is a method for molding a diffusion board of a direct type backlight module, including the steps of providing a board made of a material in which diffusion particles are mixed, passing the board through a roller set including an upper roller and a lower roller, the upper roller having a surface opposing the board and forming a micro-structure thereon, and heating and passing the board with the upper roller so as to transfer the micro-structure of the upper roller to a surface of the board and thus forming at least an optic micro-structure on the surface of the board so as to obtain a diffusion board. As such, when the diffusion board is applied to a backlight module, spreading and focusing of light can be effected without any optic film, so that the costs of the backlight module can be reduced.

### BACKGROUND OF THE INVENTION

(a) Technical Field of the Invention

The present invention relates to a method for molding a diffusion board of a direct type backlight module and an application thereof, and in particular to diffusion board that effect light focusing and directing without using optic film to thereby eliminating the costs of the optic films.

(b) Description of the Prior Art

Application of large-sized liquid crystal display (LCD) are generally notebook computers and LCD monitors, which require a backlight module that is light weight, compact, and small thickness. On the other hand, for a back light source for such applications, what are emphasized are sufficient display brightness, which should be no less than 450 cd/m², a wide viewing angle, and sharp image contrast, as well as acceptable service life. Based on both considerations, direct type backlighting is the most appealing option for large-sized LCD TV for it meets the requirement of enhanced brightness by replacing sideways-projecting light source that is adopted for reducing weight and thickness of the backlight module with direct type linear light sources of which the lighting is uniformly spread as a planar light source to radiate the liquid crystal panel.

FIG. 1 of the attached drawings shows a conventional direct type backlight module 1, which comprises at least a casing 11, a plurality of light sources 12, a diffusion board 13, and an unspecified number of optic films 14. The casing 11 forms a top opening 111 delimited by a surrounding sidewall that extends downward to a bottom of the casing 11 in a converging manner. The casing 11 has an inside surface that is made shining or on which a reflective film 112 is attached to allow the casing 11 to effect reflection of light.

The light sources 12 are commonly comprised of cold cathode fluorescent lamps (CCFLs). The light sources 12 are arranged in a parallel manner on the bottom of the casing 11. The diffusion board 13 is received in the casing 11 and positioned above the light sources 12.

the diffusion board 13 comprises a board in which diffusion beads 131 are embedded for uniformly distributing the lights from the light sources 12. The diffusion board 13 is arranged above the light sources 12 and closing the top opening 111 of the casing 11.

The optic films 14 include a diffuser 141 and a prism lens 142, which serve to correct orientation of lights and diffusion angles.

To assemble the conventional backlight module 1, the light sources 12 are first deposited on the bottom of the casing 11 through the top openings 111. The diffusion board 13 is then positioned and retained on the top opening 111 of the casing 11. The diffuser 141 and the prism lens 142 of the optic films 14 are then stack in sequence on the diffusion board 13 to complete the assembling of the direct type backlight module 1, which is best seen in FIG. 2 of the attached drawings.

In the operation of the direct type backlight module 1, the light sources 12 are energized and emit lights. A portion of the lights radiates on the diffusion board 13 directly, while the other portions are reflected and re-oriented by the inside surface of the casing 11 toward the diffusion board 13. Due to the diffusion beads 131 embedded in the diffusion board 13, when the lights travel through the diffusion board 13, the lights that come from the light sources 12 inside the casing 11 are spread by the diffusion board 13 and are thus uniformly distributed through the board 13 for radiating a liquid crystal panel A. The lights that have been spread by the diffusion board 13 are subject to further distribution by the diffuser 141 of the optic films 14 to provide more uniformly distribution of light. The prism lens 142 enhances brightness of the lights emitted out of the backlight module 1 and thus enhancing performance of the backlight module 1.

The conventional direct type backlight module, although having acceptable performance, requires a diffuser 141 for enhancing light diffusion and a prism lens 142 for properly orienting the emitted light to eventually effect uniform distribution of light. However, the diffuser 141 and the prism lens 142 that are made in the form of thin optic films are prone to warp and deformation, which lead to poor appearance of the whole backlight module. In addition, the larger the size of the films is, the tougher the assembling operation is. Further, the optical films 14 are expensive, which makes the prices of the backlight module very high.

Therefore, it is desired to have a backlight module that does not need optic films, while having acceptable performance, with reduced costs.

### SUMMARY OF THE INVENTION

The primary purpose of the present invention is to to provide a method for molding a diffusion board of a direct type backlight module, comprising the steps of providing a board made of a material in which diffusion particles are mixed, passing the board through a roller set comprising an upper roller and a lower roller, the upper roller having a surface opposing the board and forming a micro-structure thereon, and heating and pressing the board with the upper roller so as to transfer the micro-structure of the upper roller to a surface of the board and thus forming at least an optic micro-structure on the surface of the board so as to obtain a diffusion board. As such, when the diffusion board is applied to a backlight module, spreading and focusing of light can be effected without any optic film, so that the costs of the backlight module can be reduced.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a conventional direct type backlight module;

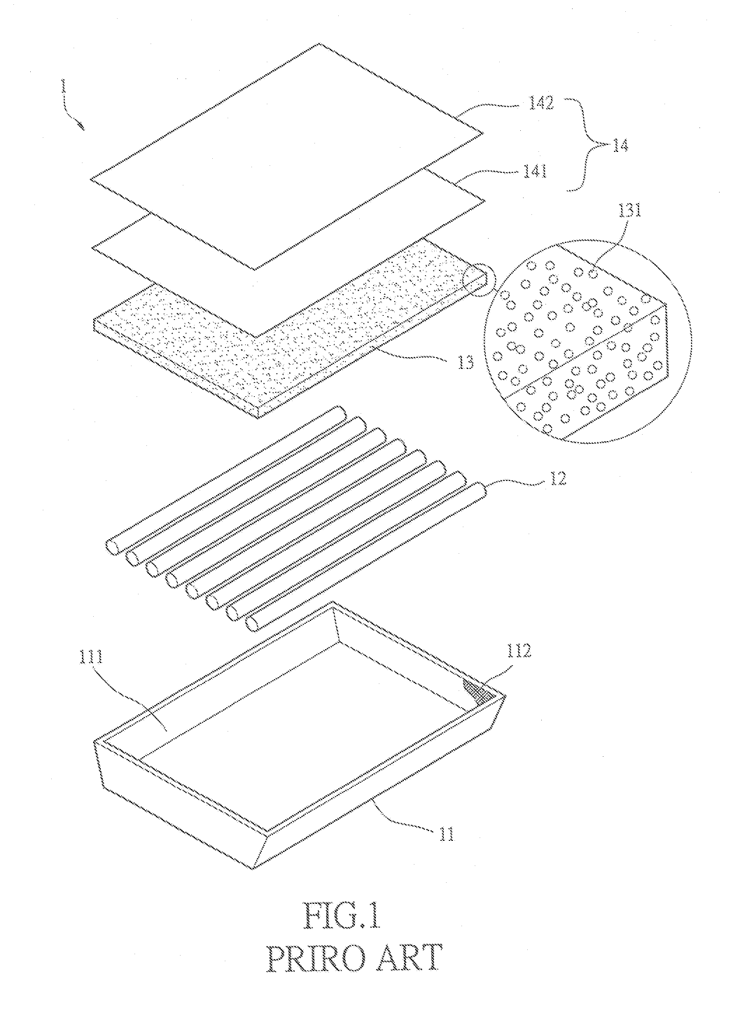

FIG. 2 is a cross-sectional view, in an exploded form, of the conventional direct type backlight module;

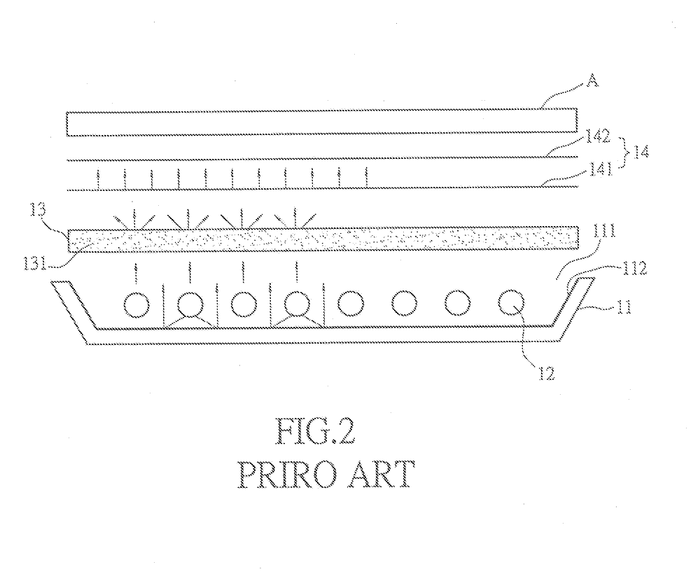

FIG. 3 is a schematic side-elevational view demonstrating a molding process of a diffusion board in accordance with the present invention;

FIG. 4 is a perspective view also demonstrating the molding process of the diffusion board illustrated in FIG. 3;

FIG. 5 is a cross-sectional view, in an exploded form, illustrating an application of the diffusion board of the present invention in a direct type backlight module;

FIG. 6 is similar to FIG. 3 but demonstrating a molding process of a diffusion board in accordance with another embodiment of the present invention;

FIG. 7 is a perspective view also demonstrating the molding process of the diffusion board illustrated in FIG. 6; and

FIG. 8 is a cross-sectional view, in an exploded form, illustrating an application of the diffusion board of said another embodiment of the present invention in a direct type backlight module.

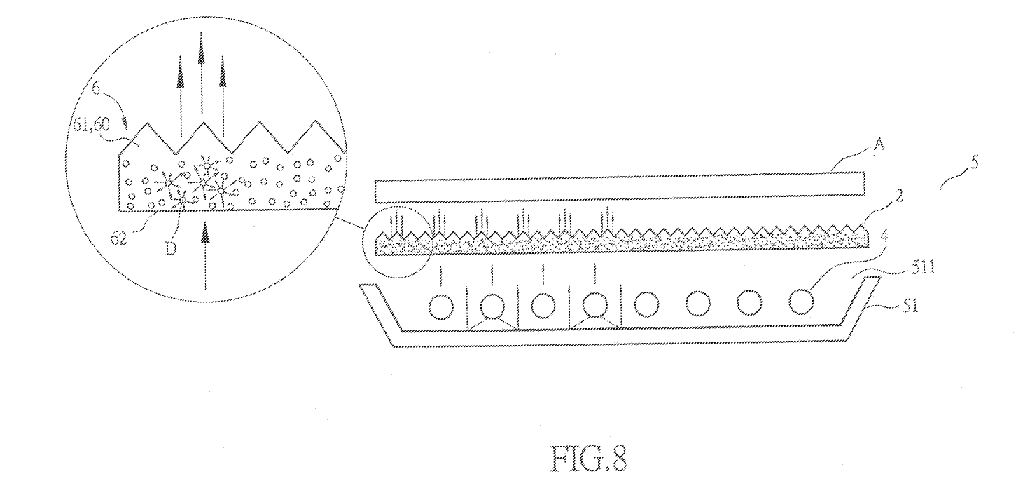

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

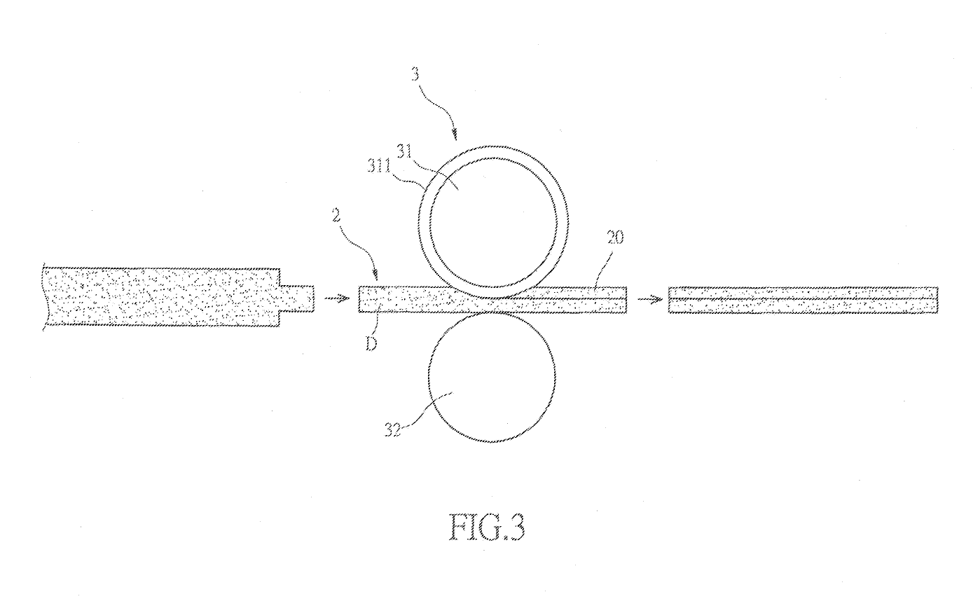

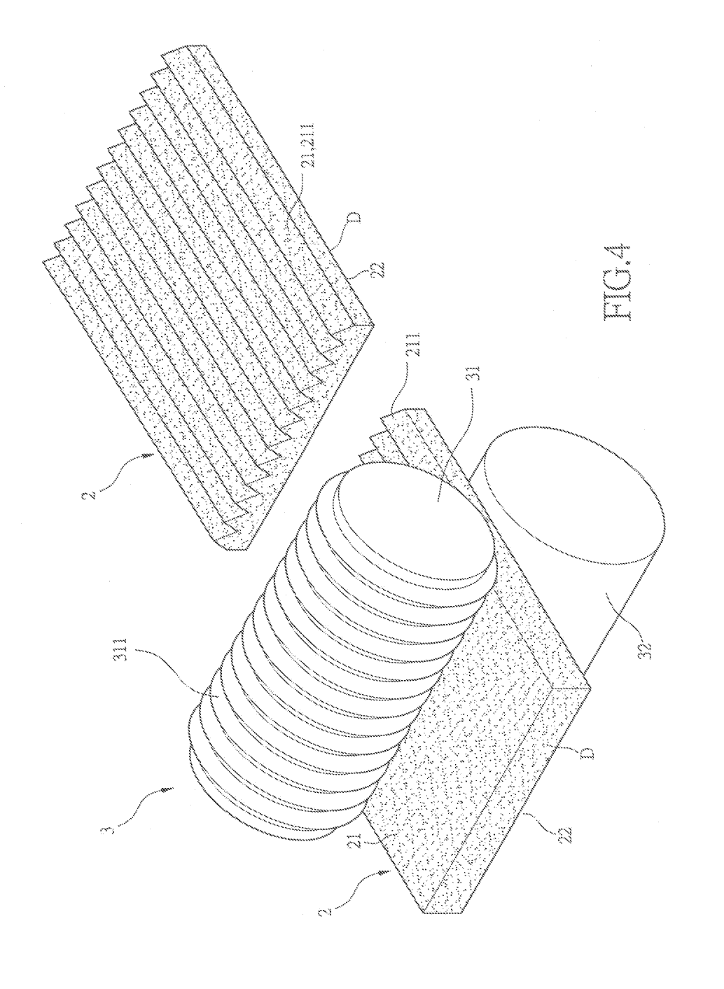

With reference to the drawings and in particular to FIG. 3, a diffusion board constructed in accordance with the present invention, generally designated with reference numeral 2, is made of material that has excellent light transmittance and containing diffusion particles D. Examples include polymethyl methacrylate (PMMA) and polycarbonates (PC). In molding the diffusion board 2, the diffusion board 2 is passed through a roller set 3, which comprises an upper roller 31 and a lower roller 32. The upper roller 31 has an outer surface on which a micro-structure 311 is formed. In the embodiment illustrated, the micro-structure 311 is composed of serration patterns of V-shaped cross-section. Apparently, patterns of other arrangements and other cross-sections can also be adopted. The lower roller 32 has an outer surface that is smooth. When the diffusion board 2 moves through the roller set 3, a surface of the diffusion board 2 that opposes the upper roller 31 is subject to pressing and heating by the upper roller 31 to transfer the same pattern of the micro-structure 311 of the upper roller 31 to the surface of the diffusion board 2 and thus forming a plurality of optic micro-structures 20 on the surface of the diffusion board 2 that induces a desired optic effect on light transmitting therethrough. This is demonstrated in FIG. 4.

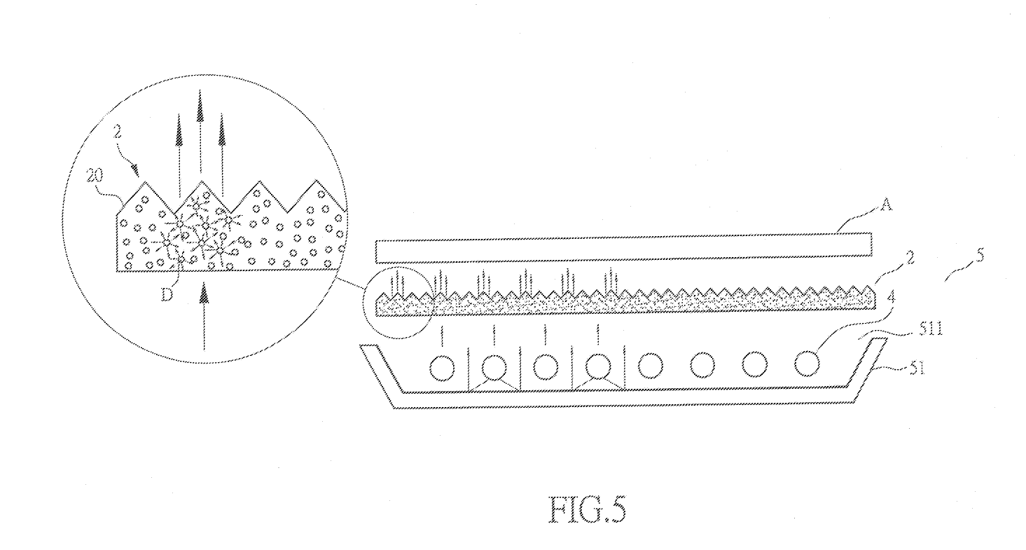

In the application of the diffusion board 2, as shown in FIG. 5, light sources 4 are positioned on a bottom of a casing 51 through a top opening 511 of the casing 51. The diffusion board 2 is then positioned and retained on the top opening 511 of the casing 51. A liquid crystal panel A is thereafter arranged above the diffusion board 2 and thus completing the assembling of a direct type backlight module 5.

In the operation of the direct type backlight module 5 of the present invention, the light sources 4 are energized to give off light, of which a portion is directly incident onto the diffusion board 2 that is located above, while the other portions are reflected and re-oriented by an inside surface of the casing 51 toward the diffusion board 2. Due to the diffusion particles D embedded in the diffusion board 2, when the lights travel through the diffusion board 2, the lights that come from the light sources 4 inside the casing 51 are spread by the diffusion particles D contained in the diffusion board 2 and are thus uniformly distributed through the diffusion board 2. The lights are focused and directed by the optic micro-structures 20 formed on the surface of the diffusion board 2 to enhance brightness of the lights for radiating the liquid crystal panel A.

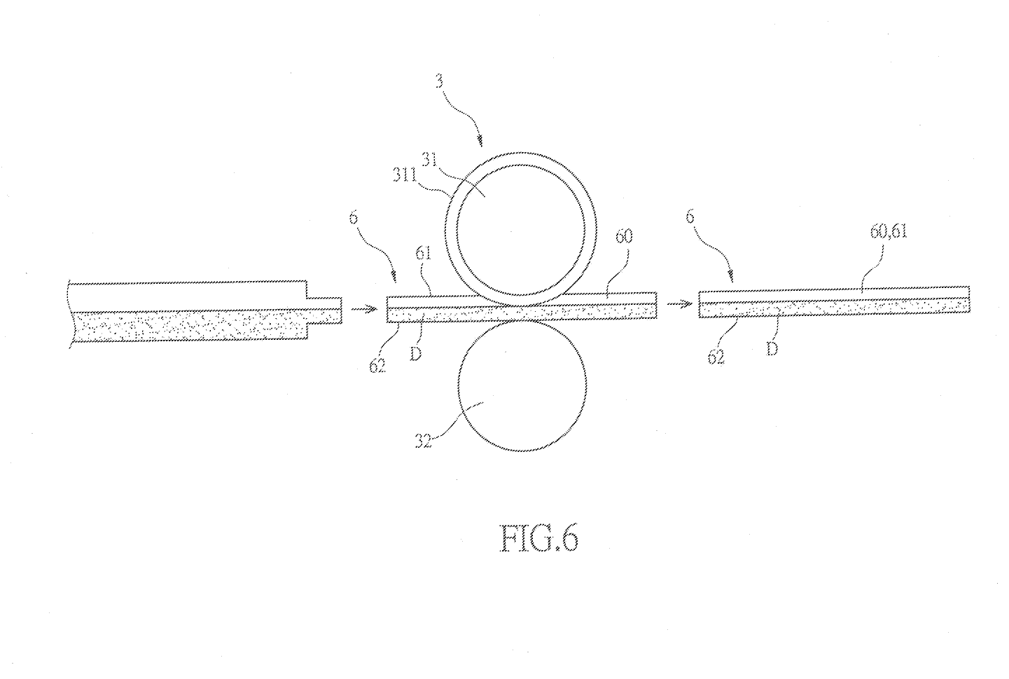

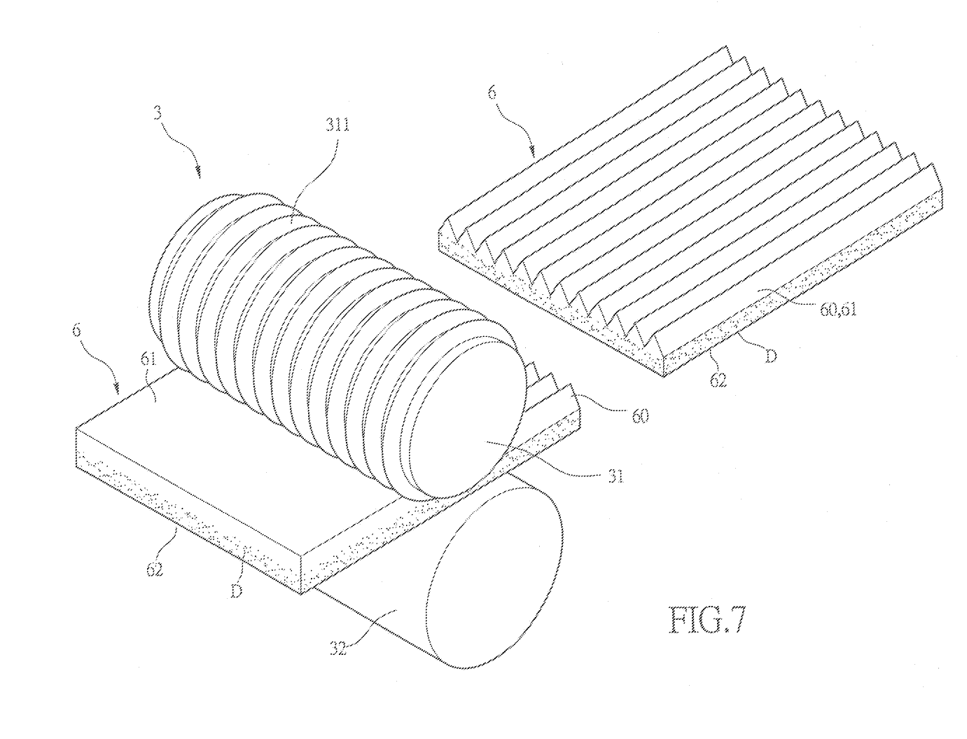

Also referring of FIG. 6, another embodiment of the present invention is shown, in which a diffusion board 6 is made of a material containing diffusion particles D and a material containing no diffusion particles D. Both materials are simultaneously rolled to mold the diffusion board 6, whereby an upper layer 61 of the diffusion board 6 contains no diffusion particles D, while only a lower layer 62 of the diffusion board 6 contains diffusion particles D. Thus, when the diffusion board 6 moves through the roller set 3, the upper roller 31 heats and presses the upper layer 61 of the diffusion board 6 to transfer the micro-structure 311 of the outer surface of the upper roller 31 to the upper layer 61 of the diffusion board 6 that contains no diffusion particles D thereby forming optic micro-structures 60 on the upper layer 61 of the diffusion board 6, as illustrated in FIG. 7.

In an application of the diffusion board 6 in the direct type backlight module 5, the light sources 4 are energized to give off light, of which a portion is directly incident onto the diffusion board 6 that is located above, while the other portions are reflected and re-oriented by an inside surface of the casing 51 toward the diffusion board 6. Due to the diffusion particles D embedded in the lower layer 62 of the diffusion board 6, when the lights travel through the lower layer 62 of the diffusion board 6, the lights that come from the light sources 4 inside the casing 51 are spread by the diffusion particles D contained in the lower layer 62 of the diffusion board 6 and are thus uniformly distributed through the diffusion board 6. The lights are focused and directed by the optic micro-structure 60 formed on the upper layer 61 of the diffusion board 6. Since no diffusion particle D is embedded in the upper layer 61 and thus the optic micro-structures 60 of the upper layer 61, when the lights travel from the lower layer 62 into the upper layer 61, the optic micro-structures 60 of the upper layer 61 may better focus and direct the traveling of the lights to thus enhance brightness of the lights for radiating the liquid crystal panel A.

A feature of the present invention is providing micro-structure 311 on the surface of the upper roller 31 of the roller set 3 so that in the molding of the diffusion board 2, 6, rolling of the diffusion board 2, 6 by the roller set 3 transfer the micro-structure 311 of the upper roller 31 to the surface of the diffusion board 2, 6 to form the optic micro-structures 20, 60 that serve to focus and direct the light traveling through the diffusion board 2, 6. The diffusion particles D contained in the diffusion board 2, 6 effectively spread the lights from the light sources 4 whereby the lights can be uniformly distributed through the diffusion board 2, 6 and then properly focused without any optic film included in the backlight module 5. As a result, costs of the backlight module are reduced.

Although the present invention has been described with reference to the preferred embodiments thereof, it is apparent to those skilled in the art that a variety of modifications and changes may be made without departing from the scope of the present invention which is intended to be defined by the appended claims.

In will be understood that each of the elements described above, or two or more together may also find a useful application in other types of methods differing form the type described above.

While certain novel features of this invention have been shown and described and are pointed out in the annexed claim, it is not intended to be limited to the details above, since it will be understood that various omissions, modifications, substitutions and changes in the forms and detail of the device illustrated and in its operation can be made by those skilled in the art without departing in any way from the spirit of the present invention.

I claim:

1. A method form molding a diffusion board of a direct type backlight module, comprising the following steps:
providing a board made of a material in which diffusion particles are mixed; and
passing the board through a roller set comprising an upper roller and a lower roller, wherein the upper roller having a surface opposing the board and forming a micro-structure thereon;
heating and pressing the board with the upper roller so as to transfer the micro-structure of the upper roller to a surface of the board and thus forming at least an optic micro-structure on the surface of the board so as to obtain a diffusion board.

2. The method as claimed in claim 1, wherein the optic micro-structure is formed so as to contain no diffusion particle therein.

3. The method as claimed in claim 1, wherein the micro-structure of the upper roller comprises serration having V-shaped cross-section.

4. A direct type backlight module, comprising:
a casing having a top opening delimited by a surrounding sidewall that converges toward a bottom of the casing;
a diffusion board having a portion in which diffusion particles are embedded and at least one optic micro-structure formed on the portion; and
at least one light source;
wherein the light source, after being energized, gives off a light, which, when traveling through the portion of the diffusion board, is spread by the diffusion particles and thus uniformly distributed through the diffusion board, the light being focused and directed by the optic micro-structure formed on the diffusion board for radiating an optic panel.

5. The direct type backlight module as claimed in claim 4, wherein the optic micro-structure is formed so as to contain no diffusion particle therein.
